(19) United States
(12) Patent Application Publication
(10) Pub. No.: US 2004/0060238 A1
(43) Pub. Date: Apr. 1, 2004

(54) Autothermal catalytic steam reformer

(76) Inventors: William B. Retallick, West Chester, PA (US); William A. Whittenberger, Leavittsburg, OH (US)

Correspondence Address: William H. Eilberg, 420 Old York Road, Jenkintown, PA, 19046, US

(21) Appl. No.: 10/211,083

(22) Filed: Aug. 2, 2002

(51) Int. Cl. C01B 3/24

(52) U.S. Cl. 48/198.3; 48/198.7; 48/127.9; 48/128; 422/189; 422/198; 422/211; 422/111

(57) ABSTRACT

A compact steam reformer produces hydrogen to power a fuel cell, such as can be used in a vehicle. The steam reformer includes a first channel, at least partly coated with a steam reforming catalyst, and a second channel, at least partly coated with a combustion catalyst, the channels being in thermal contact with each other. Heat from the combustion is used in the steam reforming reaction. The steam reformer may be provided as a stack of strips defining steam reforming channels which alternate with combustion channels. The reformer may also include a set of modules, connected in series, each module including a stack of strips as described above. The steam reformer preferably also includes a channel wherein a water-gas shift reaction occurs, to convert carbon monoxide, produced by the reformer, into carbon dioxide.

### BACKGROUND OF THE INVENTION

This invention relates to the field of catalytic steam reforming of hydrocarbons to make hydrogen.

The hydrogen produced by the present invention may be used, for example, to operate a fuel cell. In a fuel cell, hydrogen is consumed during the process of producing electric power.

Steam reforming refers to the endothermic reaction whereby hydrogen is produced from methane, or from some other hydrocarbon. The steam reforming reaction, when the fuel is methane, is as follows:

CH₄+H₂O→CO+3H₂

For reforming a C8 hydrocarbon, the reaction is:

C₈H₁₈+8H₂O→8CO+17H₂

If the fuel cell is to be used to power a vehicle, the fuel cell, and the steam reformer used to supply hydrogen to the fuel cell, must be compact. Also, steps must be taken to reduce or eliminate the carbon monoxide products, which will quickly poison the membrane in the fuel cell. The present invention provides a practical, compact catalytic steam reformer, which can be used on a vehicle, or in other environments where space is severely limited.

### SUMMARY OF THE INVENTION

In its simplest form, the steam reformer of the present invention comprises a reactor having a first strip of metal which is coated with a reforming catalyst on one side and with a combustion catalyst on the other side. This strip is confined between two uncoated strips which define a combustion channel on one side of the first strip and a reforming channel on the other side. Hydrocarbon plus steam flows through the reforming channel and hydrocarbon plus air flows through the combustion channel. Hydrocarbon is injected into the combustion channel at points along the length of the channel to maintain the temperature. Heat from the combustion channel is absorbed in the adjacent steam reforming channel, to drive the steam reforming reaction.

In a more preferred embodiment, the reactor comprises a stack of strips, defining a plurality of channels. Alternate channels are coated, at least partially, with a steam reforming catalyst, and the remaining channels are coated, at least partially, with a combustion catalyst. A mixture of hydrocarbon fuel and steam is directed into the steam reforming channels, and a mixture of hydrocarbon fuel and air is directed into the combustion channels. Additional hydrocarbon fuel is injected along the length of the combustion channels. As before, heat from the combustion channels is absorbed in the adjacent steam reforming channels.

In another preferred embodiment, the present invention comprises a plurality of stacks or modules, each constructed as described above. In this case, the additional hydrocarbon fuel can be injected before each stack, i.e. at the junction between successive stacks.

In another preferred embodiment, the steam reforming reaction is followed by a water-gas shift reaction, for converting carbon monoxide to carbon dioxide and hydrogen. Each steam reforming channel (in the case of a single-module reactor) or each steam reforming channel of the last stack (in the case of a plurality of stacks connected in series) is connected to a channel which is at least partially coated with a water-gas shift catalyst. A cooling channel is provided adjacent to each such water-gas shift channel. In the water-gas shift channel, carbon monoxide reacts with water and is converted to carbon dioxide and hydrogen. The cooling channel reduces the temperature of the water-gas shift reaction so as to maximize the conversion of carbon monoxide to carbon dioxide.

The present invention therefore has the primary object of providing a catalytic steam reformer.

The invention has the further object of providing an autothermal steam reformer, i.e. one which itself supplies the heat necessary to drive the steam reforming reaction.

The invention has the further object of providing a steam reformer which comprises a plurality of channels which are in intimate contact with each other.

The invention has the further object of providing a steam reformer for generating hydrogen for use in a fuel cell.

The invention has the further object of providing a steam reformer which is compact.

The invention has the further object of providing a steam reformer which is sufficiently compact that the reformer can be used in a vehicle.

The invention has the further object of providing a compact steam reformer which includes means for converting carbon monoxide produced by the steam reforming process, to carbon dioxide and hydrogen.

The invention has the further object of providing a compact and long-lived catalytic steam reformer for producing hydrogen for use in a fuel cell in a vehicle.

The invention has the further object of providing a method of generating hydrogen, through the use of a steam reformer.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a simplified schematic diagram of a first embodiment of the steam reformer of the present invention.

FIG. 2 provides a schematic diagram of an alternative embodiment of the present invention, wherein the reformer comprises a stack of channels in which combustion channels alternate with reforming channels.

FIG. 3 provides a schematic diagram of a preferred embodiment of the invention, wherein a plurality of reformers, each of the type illustrated in FIG. 2, are arranged in series.

FIG. 4 provides an exploded perspective view of an embodiment of the present invention, wherein each reactor is formed from a stack of dimpled plates.

FIG. 5 provides a graph showing an optimum cooling curve for the water-gas shift reaction conducted according to the present invention.

FIG. 6 provides a schematic diagram of an embodiment of the present invention in which a steam reformer is combined with a water-gas shift reactor. FIG. 7 provides a schematic diagram of a plurality of steam reforming reactors, made according to the present invention, in which the flows in the reforming channels and the combustion channels are mutually countercurrent.

### DETAILED DESCRIPTION OF THE INVENTION

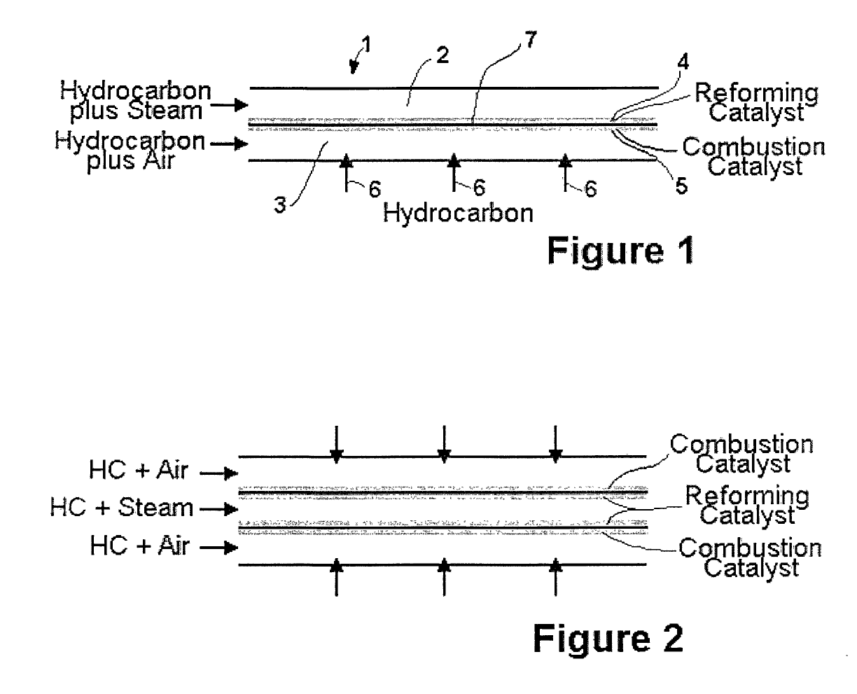

The simplest form of the invention is shown in the schematic diagram of FIG. 1. Reactor 1 comprises three strips which define two adjacent channels. The first channel 2 is a reforming channel, i.e. it is where the steam reforming reaction occurs. The second channel 3 is a combustion channel.

In the embodiment shown, the middle strip 7 is coated on one side with reforming catalyst 4, and on the other side with combustion catalyst 5. Thus, first channel 2 has walls which are partially coated with reforming catalyst 4, and second channel 3 has walls which are partially coated with combustion catalyst 5. By “reforming catalyst” is meant a catalyst that promotes the steam reforming reaction discussed above.

A mixture of a hydrocarbon and steam is injected as shown at the left-hand side of the reforming channel. A mixture of a hydrocarbon and air is injected as shown at the left-hand side of the combustion channel. The hydrocarbon comprises fuel for the combustion.

The steam reforming reaction is endothermic, which means that it absorbs heat. The heat is supplied by the combustion which proceeds in the combustion channel, which is, in the embodiment of FIG. 1, located on the other side of the strip.

In the arrangement of FIG. 1, the middle strip 7 is coated, and the other strips are not coated. It is possible to use other coating schemes, whereby the steam reforming channels and/or combustion channels can be fully coated, or partially coated to varying degrees. All of such alternatives are included within the scope of the present invention.

If all of the fuel were injected at the inlet, the fuel would tend to burn there, causing a large temperature increase at the inlet. But the steam reforming reaction is not fast enough to absorb all of the heat produced at the inlet, and the result would be an inefficient reformer. In a practical reformer, the conversion of the hydrocarbon must exceed about 95%.

The desired efficiency can be achieved by injecting hydrocarbon fuel at points along the combustion channel. Doing so will increase the combustion temperature to 800-900° C. at each such point.

FIG. 1 shows additional hydrocarbon fuel being injected into the combustion channel, at various positions along the channel, as indicated by arrows 6. Heat from the combustion is conducted through the common wall of the two channels, and this heat is absorbed by the endothermic steam reforming reaction. Note that additional fuel, but not air, is injected along the combustion path.

In the preferred embodiment, the hydrocarbon fuel injected into the reforming channel has the same composition as the fuel injected into the combustion channel. Thus, the two channels can be supplied with fuel from the same source. Catalytic combustion in the combustion channel supplies the heat to drive the reforming reaction.

FIG. 2 provides a schematic diagram of another embodiment of the invention, having increased throughput. The reactor shown in FIG. 2 includes a stack of strips, of which four are shown. The strips define channels, in which alternate channels are steam reforming channels, and the remaining channels are combustion channels. The steam reforming channels are at least partially coated with steam reforming catalyst, and the combustion channels are at least partially coated with combustion catalyst. The mixture of hydrocarbon and steam is injected into the reforming channels, i.e. the channels coated with the reforming catalyst, and the mixture of hydrocarbon and air is injected into the combustion channels. As in FIG. 1, hydrocarbon fuel is also added (without additional air), simultaneously, at spaced points along the length of the combustion channels, as indicated by the arrows. Combustion air is injected at one end of each combustion channel.

When one uses a stack of strips, such as in the embodiment of FIG. 2, one must provide piping to deliver hydrocarbon and air, preferably from the same source, to each of the combustion channels, and to deliver hydrocarbon and steam to each of the reforming channels. Such piping is illustrated only schematically in FIG. 2. Also, for clarity of illustration, the figure does not show the means for preventing the strips from nesting together. Such means could include dimples formed in the strips.

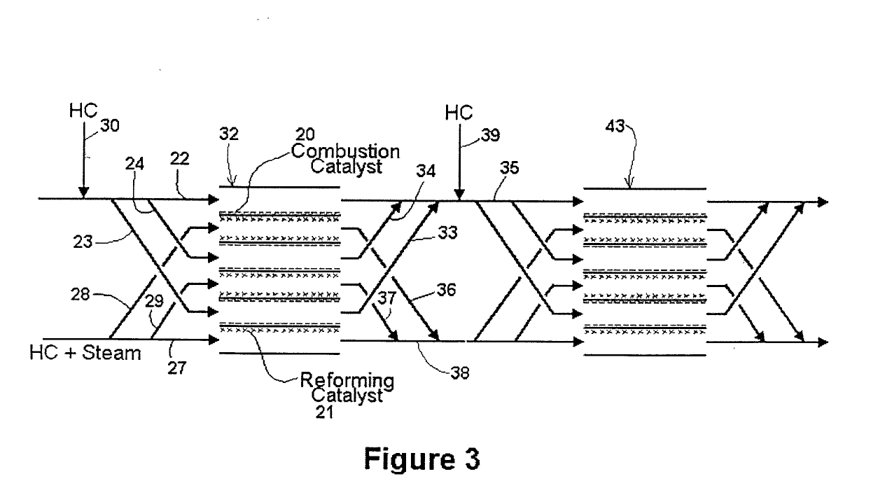

FIG. 3 provides a schematic diagram of a preferred embodiment of the present invention, in which there are a plurality of reactors arranged in series. Each reactor, such as reactors 32 and 43, comprises a stack of strips. Only two such reactors are shown in FIG. 3, but it is understood that further reactors could be provided. In each stack, alternate channels are coated, completely or partially, with a combustion catalyst 20, and the remaining channels are coated, completely or partially, with a reforming catalyst 21. For purposes of illustration, the combustion catalyst is symbolized by dashes, and the reforming catalyst is represented by x's.

Conduit 22 carries a mixture of hydrocarbon (HC) fuel and air, and is intended to supply the various combustion channels. Conduits 23 and 24 branch off from conduit 22, and supply other combustion channels with the fuel-air mixture. In practice, there are many more channels than illustrated, and there are a corresponding number of conduits to supply them.

Conduit 27 carries a mixture of hydrocarbon fuel and steam, and is intended to supply the various steam reforming channels. Conduits 28 and 29 branch off from conduit 27, and supply other reforming channels with the fuel-steam mixture. As is the case for the combustion channels, a practical reactor will have many more channels than the number shown in the drawings, and there will be a correspondingly increased number of conduits to supply fuel and steam to all of the reforming channels.

The fuel in the fuel-air mixture in conduit 22 derives ultimately from a source intended to supply the entire system, though the fuel-air mixture in conduit 22 may have passed through one or more reactor stages before arriving at the particular reactor shown. Both fuel and air enter the first stage. Additional fuel, but not air, is injected before each reactor stage, as symbolized by conduit 30. The fuel entering through conduit 30 comes directly from the source, which may be the same source which supplies all other fuel to the system, and has not passed through any reactor stages before reaching conduit 30. Thus, conduit 30 corresponds generally to the injection of fuel symbolized by the arrows disposed along the length of the reactors shown in FIGS. 1 and 2. Note that the additional fuel entering through conduit 30 is injected into the fuel-air mixture so that it is automatically distributed among the individual combustion channels.

On the output side of reactor 32, conduits 33 and 34 merge into conduit 35, to carry combustion products out of the system, or into the next reactor stage. Similarly, conduits 36 and 37 merge with conduit 38 to carry the products of the reforming reaction out of the system or into the next reactor stage. As before, a new injection of fuel, for combustion, is made through conduit 39, similar to conduit 30.

One difference between the embodiments of FIGS. 1 and 3 is that the fuel in FIG. 1 is injected at various points along a single combustion channel, whereas in FIG. 3, the additional fuel is injected between adjacent reactors arranged in series. The result in both cases is essentially the same.

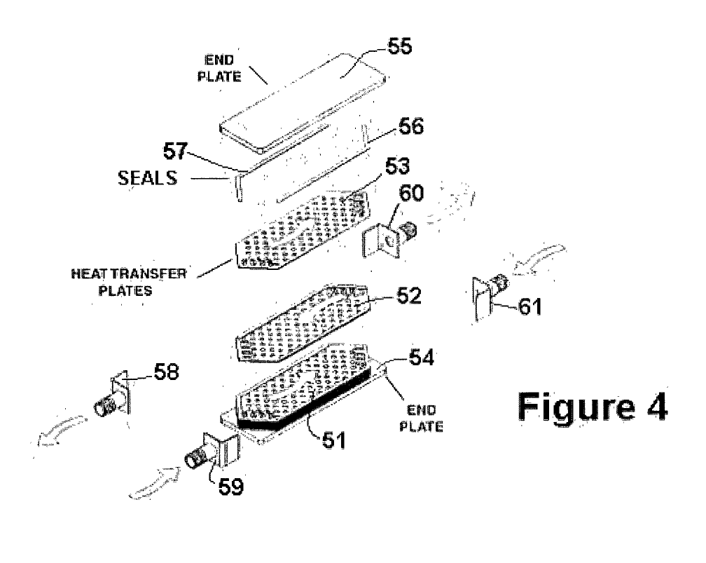

The diagrams of FIGS. 1-3 are not limited to a particular structure. Many different structures could be used to accomplish what is shown in these figures. One way to make a commercial reformer system is to combine a series of welded plate heat exchangers, such as those that are available from Tranter, Inc. Such an arrangement is shown in FIG. 4, and described below.

FIG. 4 shows a stack of heat transfer plates 51, 52, and 53. These heat transfer plates include dimples which prevent the plates from nesting. The heat transfer plates are held together between flat end plates 54 and 55. Also, the sides of the channels defined by the heat transfer plates are sealed by seals 56 and 57, which are metal pieces that close off the sides. Thus, the spaces between adjacent heat transfer plates comprise fully sealed channels. In accordance with the present invention, the channels defined by the plates are alternately coated, either fully or partially, with reforming catalyst and combustion catalyst. Suitable conduits are provided, on either end of the channels, to direct the gas flows in the manner dictated by FIGS. 1-3. These conduits are symbolized by ports 58, 59, 60, and 61, but for purposes of clarity, the diagram does not show connections between the ports and the channels. The above is only one of many ways by which the structure illustrated in FIG. 3 can be realized in practice.

As noted above, the steam reforming reaction produces carbon monoxide. Carbon monoxide will poison the membrane in a fuel cell, even in very small concentrations. It is therefore necessary to follow the reforming reaction with what is known as the “water-gas shift” reaction, which converts carbon monoxide to carbon dioxide, as follows:

CO+H₂O→CO₂+H₂

Note that one produces hydrogen both from the steam reforming reaction and from the water-gas shift reaction.

In the compact reactor of the present invention, the water-gas shift reaction is conducted in a channel that is just a continuation of the steam reforming channel. The catalysts can even be the same.

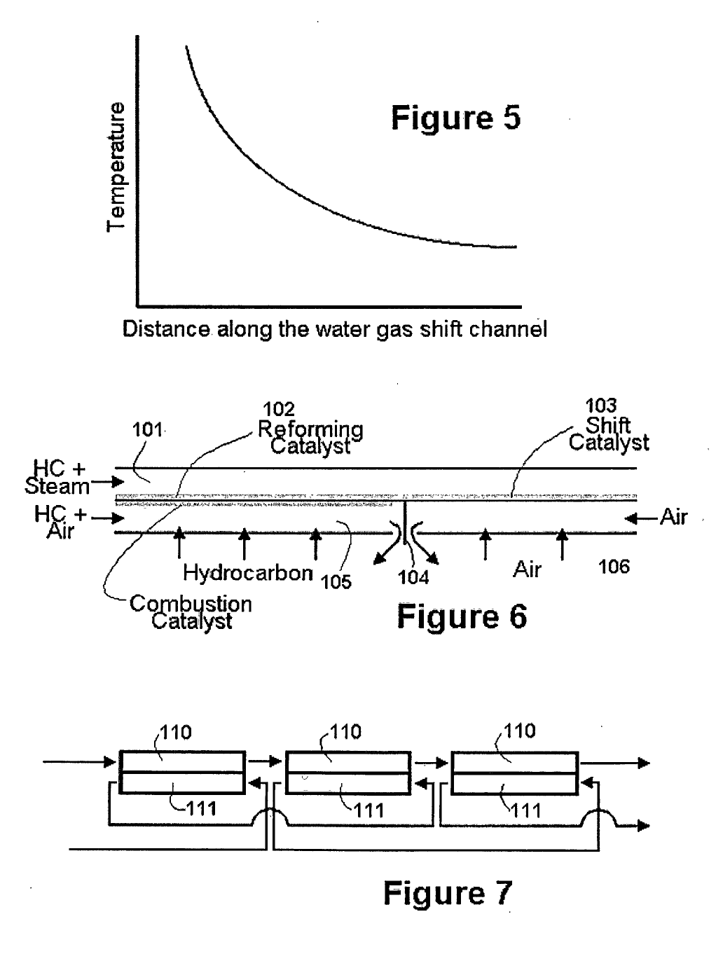

The water-gas shift reaction is exothermic, so that the equilibrium conversion to CO₂ and H₂ increases as the temperature decreases. The reaction rate also decreases as the temperature decreases. There is thus an optimum cooling curve, which maximizes the final conversion, when the outlet temperature has fallen to about 200° C., where the reaction rate is slow. This would include rapid cooling at high temperature and fast reaction rate, and slow cooling as the final temperature is approached. This optimum cooling curve is shown in FIG. 5. In operating the water-gas shift reactor, one seeks to obtain a cooling profile as represented by this curve. To do so, one injects air into the cooling channel. This cools the channel so as to bring the reaction closer to equilibrium, so that the water-gas shift reaction goes nearly to completion.

FIG. 6 provides a schematic diagram of a reactor which carries out both the steam reforming and the water-gas shift reactions. Reforming channel 101 is coated, at least partially, with reforming catalyst 102, on the left-hand side of the channel, and with water-gas shift catalyst on the right-hand side. The boundary between the reforming catalyst and the water-gas shift catalyst coincides with baffle 104 that separates the combustion channel 105 from cooling channel 106.

In the embodiment wherein there are a plurality of reactors, as shown in FIG. 3, the reactor of FIG. 6 is located at the end of the series, i.e. at the outlet end of the system. That is, there is only one water-gas shift reactor. Note, however, that the reactor shown in FIG. 6 may be much longer than any of the reactors depicted in FIG. 3. The outlet of the water-gas shift channel comprises the output of the system, which contains hydrogen and carbon dioxide, with only traces of carbon monoxide.

In the embodiments discussed so far, the reforming stream and the combustion gas flow concurrently through the reactors. Alternatively, these two streams can be mutually countercurrent. Such an arrangement is shown schematically in FIG. 7. Thus, for example, if the reforming channels are those identified by reference numeral 110, and the combustion channels are those identified by reference numeral 111, it is seen that the flow of combustion gas, in each reactor, is in the opposite direction to that of the flow of reforming gas. For simplicity of illustration, FIG. 7 does not show a water-gas shift stage, but it is understood that such a stage can be appended to the system as described above.

A possible advantage of countercurrent flow is that it may create a smoother temperature profile through the series of exchangers.

It is an important feature of the present invention that the combustion channels and the steam reforming channels be in intimate thermal contact. Heat from the combustion channel must be able to flow unimpeded to an adjacent reforming channel to drive the reforming reaction. As illustrated in the drawings, the preferred way of insuring such intimate thermal contact is to have a system in which at least some of the metal strips are coated on one side with combustion catalyst and on the other side with reforming catalyst. Thus, only the metal of the strip separates a combustion channel from a reforming channel, and heat can freely flow from the former to the latter.

A preferred steam reforming catalyst is rhodium or palladium, in combination with zirconia. Rhodium can be used as the catalyst for both the steam reforming reaction and the water-gas shift reaction. It is preferred to use platinum and/or palladium as the combustion catalyst.

A preferred catalyst system, for use in the present invention, is described below.

The source of the zirconia was a water-based solution of the oxynitrate ZrO(NO₃)₂, a commercial product, which contained 20% ZrO₂ and 20% HNO₃. The purchased solution was diluted with water. NH₄OH was added until the pH was 7.9. The exact value of the pH is believed not to be important.

A precipitate of Zr(OH)₄ was collected on a filter. A solution of rhodium nitrate was stirred into the wet filter cake. The mixture was stirred with a magnetic mixer, on a hotplate. Some water was evaporated during this process.

The resulting product was a thin “soup” of yellow color. This soup comprises a washcoat which could then be painted onto a metal strip with a brush. After being applied to the strip, each coat was calcined.

The rhodium nitrate solution contained excess HNO₃ which reacted with the Zr(OH)₄ to make the soup.

The same result was obtained by substituting palladium nitrate for the rhodium nitrate. In both cases, the coating was found to adhere to the strip very well.

The present invention has a primary advantage of compactness. This advantage is achieved by providing combustion on one side of a strip and steam reforming on the other. Also, the use of a stack of multiple layers further enhances the ability of the reactor to work in a compact space. The compactness is further enhanced by providing the reforming and water-gas shift reactions in the same channel, and by providing the cooling air in what would otherwise be a continuation of the combustion channel, as shown in FIG. 6.

The invention can be modified in various ways. The arrangement shown in FIG. 4 is only one example of a realization of the structure illustrated schematically in FIGS. 1-3. Other steam reforming catalysts could be used instead of those mentioned above. Also, the catalyst coating may be applied by any of the many known techniques, such as painting the coating onto the strip with a brush, vapor deposition, spray coating, or by other methods. Such modifications, which will be apparent to those skilled in the art, should be considered within the spirit and scope of the following claims.

What is claimed is:

1. A steam reformer, comprising:
a first channel having a wall which is at least partly coated with a steam reforming catalyst, and
a second channel having a wall which is at least partly coated with a combustion catalyst,
wherein the second channel is positioned sufficiently close to the first channel to permit heat transfer from the second channel to the first channel, and
wherein the steam reformer further comprises a plurality of means for introducing fuel into the second channel, said plurality of introducing means being disposed at intervals along a length of the first channel.

2. The steam reformer of claim 1, wherein the first and second channels have inlet and outlet ends, and wherein the outlet end of the first channel is connected to a channel having a wall at least partly coated with a water-gas shift catalyst, wherein the outlet end of the second channel is connected to a cooling channel having means for introducing air into the cooling channel.

3. The steam reformer of claim 1, wherein the steam reforming catalyst is selected from the group consisting of rhodium and palladium.

4. The steam reformer of claim 2, wherein the steam reforming catalyst is selected from the group consisting of rhodium and palladium, and wherein the water-gas shift catalyst is the same catalyst as the steam reforming catalyst.

5. The steam reformer of claim 4, wherein the steam reforming catalyst is impregnated into a washcoat of zirconia which is applied to a surface of the steam reforming channel.

6. A steam reformer, comprising:
a first channel having a wall which is at least partly coated with a steam reforming catalyst, and
a second channel having a wall which is at least partly coated with a combustion catalyst,
wherein the second channel is positioned sufficiently close to the first channel to permit heat transfer from the second channel to the first channel, and
wherein the first and second channels have inlet and outlet ends, and wherein the outlet end of the first channel is connected to a channel having a wall at least partly coated with a water-gas shift catalyst, wherein the outlet end of the second channel is connected to a cooling channel having means for introducing air into the cooling channel.

7. A steam reformer, comprising:
a) a plurality of metal strips, the strips being spaced from each other to define a plurality of channels for gas flow, each channel having an inlet end and an outlet end,
b) wherein some of said channels comprise steam reforming channels which are at least partially coated with a steam reforming catalyst,
c) wherein some of said channels comprise combustion channels which are at least partially coated with a combustion catalyst, and
wherein the steam reforming channels are interspersed with the combustion channels to allow heat from a combustion channel to flow into an adjacent steam reforming channel,
wherein the outlet end of each steam reforming channel is connected to a channel having a wall at least partly coated with a water-gas shift catalyst, wherein the outlet end of each combustion channel is connected to a cooling channel having means for introducing air into the cooling channel.

8. The steam reformer of claim 7, wherein each combustion channel is separated from each cooling channel by a baffle.

9. The steam reformer of claim 7, further comprising a plurality of means for introducing fuel into each combustion channel, said plurality of introducing means being disposed at intervals along a length of each combustion channel.

10. The steam reformer of claim 7, wherein the steam reforming catalyst is selected from the group consisting of rhodium and palladium.

11. The steam reformer of claim 7, wherein the steam reforming catalyst is selected from the group consisting of rhodium and palladium, and wherein the water-gas shift catalyst is the same catalyst as the steam reforming catalyst.

12. The steam reformer of claim 11, wherein the steam reforming catalyst is impregnated into a washcoat of zirconia which is applied to a surface of the steam reforming channel.

13. A steam reformer comprising a plurality of modules connected in series, each module comprising:
a first channel having a wall which is at least partly coated with a steam reforming catalyst, and
a second channel having a wall which is at least partly coated with a combustion catalyst,
wherein the second channel is positioned sufficiently close to the first channel to permit heat transfer from the second channel to the first channel.

14. The steam reformer of claim 13, wherein a first channel of one of said modules is connected to a channel having a wall at least partly coated with a water-gas shift catalyst, and wherein a second channel of said one of said modules is connected to a cooling channel having means for introducing air into the cooling channel.

15. The steam reformer of claim 13, further comprising means for introducing fuel separately to each module.

16. The steam reformer of claim 14, further comprising means for introducing fuel separately to each module.

17. The steam reformer of claim 14, wherein the steam reforming catalyst is selected from the group consisting of rhodium and palladium.

18. The steam reformer of claim 14, wherein the steam reforming catalyst is selected from the group consisting of rhodium and palladium, and wherein the water-gas shift catalyst is the same catalyst as the steam reforming catalyst.

19. The steam reformer of claim 17, wherein the steam reforming catalyst is impregnated into a washcoat of zirconia which is applied to a surface of the steam reforming channel.

20. A steam reformer comprising a plurality of modules connected in series, each module comprising a stack of strips defining a plurality of channels, wherein alternate channels are coated with a steam reforming catalyst and are designated steam reforming channels, and wherein the remaining channels are coated with a combustion catalyst and are designated combustion channels, and means for introducing fuel to the combustion channels of each module.

21. The steam reformer of claim 20, wherein a steam reforming channel of one of said modules is connected to a water-gas shift channel having a wall at least partly coated with a water-gas shift catalyst, and wherein a combustion channel of said one of said modules is connected to a cooling channel having means for introducing air into the cooling channel, wherein the cooling channel is located sufficiently close to said water-gas shift channel to cool said water-gas shift channel.

22. The steam reformer of claim 20, wherein the modules are connected by conduits, and wherein the steam reformer comprises means for introducing fuel separately to at least some of said conduits.

23. The steam reformer of claim 20, wherein the steam reforming catalyst is selected from the group consisting of rhodium and palladium.

24. The steam reformer of claim 21, wherein the steam reforming catalyst is selected from the group consisting of rhodium and palladium, and wherein the water-gas shift catalyst is the same catalyst as the steam reforming catalyst.

25. The steam reformer of claim 23, wherein the steam reforming catalyst is impregnated into a washcoat of zirconia which is applied to a surface of the steam reforming channel.

26. A steam reformer comprising a plurality of modules connected in series, each module comprising a stack of strips defining a plurality of channels, wherein alternate channels are coated with a steam reforming catalyst and are designated steam reforming channels, and wherein the remaining channels are coated with a combustion catalyst and are designated combustion channels,
wherein a steam reforming channel of one of said modules is connected to a water-gas shift channel having a wall at least partly coated with a water-gas shift catalyst, and wherein a combustion channel of said one of said modules is connected to a cooling channel having means for introducing air into the cooling channel, wherein the cooling channel is located sufficiently close to said water-gas shift channel to cool said water-gas shift channel.

27. A method of making hydrogen in a compact space, comprising:
a) directing a mixture of a hydrocarbon fuel and steam into a steam reforming channel which is at least partially coated with a steam reforming catalyst,
b) simultaneously directing a mixture of a hydrocarbon fuel and air into a combustion channel which is at least partially coated with a combustion catalyst, wherein the combustion channel is in thermal contact with the steam reforming channel, and
c) injecting additional hydrocarbon fuel at a plurality of points along the combustion channel.

28. The method of claim 27, further comprising directing products of a steam reforming reaction, from the steam reforming channel, into a water-gas shift channel which is coated with a water-gas shift catalyst.

29. The method of claim 28, further comprising cooling the water-gas shift channel by directing air into a cooling channel which is adjacent to the water-gas shift channel.

30. The method of claim 27, further comprising selecting the steam reforming catalyst from the group consisting of rhodium and palladium.

31. The method of claim 28, further comprising selecting the steam reforming catalyst from the group consisting of rhodium and palladium, and selecting the water-gas shift catalyst to be the same catalyst as the steam reforming catalyst.

32. The method of claim 30, wherein the steam reforming catalyst is applied to a surface of the steam reforming channel by impregnating the steam reforming catalyst into a washcoat of zirconia.
